(19) United States
(12) Patent Application Publication
(10) Pub. No.: US 2026/0027581 A1
(43) Pub. Date: Jan. 29, 2026

(54) Dispensing and Application Device

(71) Applicant: Onnies LLC, Casselberry, FL (US)

(72) Inventor: Dustin Onofre, Casselberry, FL (US)

(73) Assignee: Onnies, Casselberry, FL (US)

(21) Appl. No.: 19/280,383

(22) Filed: Jul. 25, 2025

Related U.S. Application Data
(60) Provisional application No. 63/676,157, filed on Jul. 26, 2024.

(51) Int. Cl. B05C 17/005; B05C 9/10; B05C 9/12

(52) U.S. Cl. CPC B05C 17/00569; B05C 9/10; B05C 9/12

(57) ABSTRACT

A device for dispensing and applying a material includes a hollow body having a first end with a tapered tip and a second closed end, wherein the tapered tip is open to allow the material to be dispensed therethrough, a mechanism positioned within the second closed end, wherein, when activated, the mechanism forces the material through the tapered tip, and an applicator coupled to the hollow body.

### CROSS REFERENCE TO RELATED APPLICATIONS

This application claims priority to U.S. Provisional Application No. 63/676,157, filed Jul. 26, 2024, entitled “Dispensing and Application Device.” The entire disclosure of which is hereby incorporated herein by reference.

### BACKGROUND

### 1. Field of the Invention

This invention is directed to a device for dispensing matter and applying the dispensed matter. Specifically, the invention is directed to an all-in-one device for dispensing and applying spackle.

### 2. Description of the Background

Spackle and joint compound (often referred to as drywall mud) are used for repairing and installing drywall. Spackle is typically used for repairing holes, cracks, indentations and other defects in walls, while joint compound is used to blemishes from the surface of drywall, such as fasteners, damage, or drywall tape. Both come in large containers or tubes and several tools need to be used to apply and finish the application of the materials. For example, first the wall must be prepared to receive the spackle or joint compound with various tools, then a putty knife or similar tool is used to remove the spackle or joint compound from the container and apply it to a wall. Finally, once dry, the spackle or joint compound needs to be sanded to smooth out the finish.

Carrying around the spackle and/or joint compound along with all of the necessary tools can be heavy and bulky. Therefore, there is a need for an all-in-one device that includes the spackle or joint compound and all the necessary tools.

### SUMMARY

The present invention overcomes the problems and disadvantages associated with current strategies and designs and provides new tools for dispensing and applying a material.

One embodiment of the invention is directed to a device for dispensing and applying a material. The device includes a hollow body having a first end with a tapered tip and a second closed end, wherein the tapered tip is open to allow the material to be dispensed therethrough, a mechanism positioned within the second closed end, wherein, when activated, the mechanism forces the material through the tapered tip, and an applicator coupled to the hollow body.

In a preferred embodiment, the material is at least one of spackle, joint compound, glue, paint, epoxy, wood filler, resin, ink, and a solvent. Preferably, the first end is adapted to accept a cartridge of the material. At least one of the first end and the second end preferably has a window to allow access to and/or viewing of the contents of the body. Preferably, the device is pen-shaped. In a preferred embodiment, the mechanism is at least one of manually and electromechanically operated. The mechanism is preferably at least one a pump, a screw drive, a plunger, or a press. Preferably, the closed end is a surface preparation and/or surface finishing tool. In a preferred embodiment, the applicator is detachable from and re-attachable to the body. Preferably, the device is a drywall repair tool.

Another embodiment of the invention is directed to a system for dispensing and applying a material. The system includes, a hollow body having a first end with a tapered tip and a second closed end, a cartridge of the material positioned within the first end, wherein the tapered tip is open to allow the material to be dispensed therethrough, a mechanism positioned within the second closed end, wherein, when activated, the mechanism forces the material from the cartridge and through the tapered tip, and an applicator coupled to the hollow body.

Preferably, the material is at least one of spackle, joint compound, glue, paint, epoxy, wood filler, resin, ink, and a solvent. In a preferred embodiment, the cartridge of the material has a movable stopper adapted to press against the material and force the material out of the cartridge. Preferably, at least one of the first end and the second end has a window to allow access to and/or viewing of the contents of the body. The system is preferably pen-shaped. In a preferred embodiment, the mechanism is at least one of manually and electromechanically operated. Preferably, the mechanism is at least one a pump, a screw drive, a plunger, or a press. The closed end is preferably a surface preparation and/or surface finishing tool. Preferably, the applicator is detachable from and re-attachable to the body. Preferably, the system is a drywall repair tool.

Other embodiments and advantages of the invention are set forth in part in the description, which follows, and in part, may be obvious from this description, or may be learned from the practice of the invention.

### DESCRIPTION OF THE FIGURES

FIG. 1 depicts a front view of the material dispensing and application device.

FIGS. 2A-2B depict back views of the material dispensing and application device.

FIGS. 2C-2D depict front and back views of an application spatula.

FIGS. 3A-C depict the components of the material dispensing and application device.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention

A problem in the art capable of being solved by the embodiments of the present invention is repairing minor holes, cracks, indentations, and other defects in drywall. While this invention is described with respect to repairing drywall, the invention can be used in any number of different applications. Depending on the application, the contents of the invention may differ.

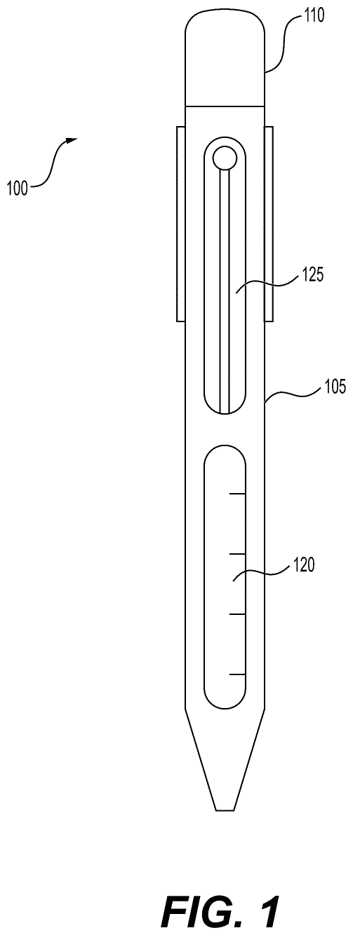

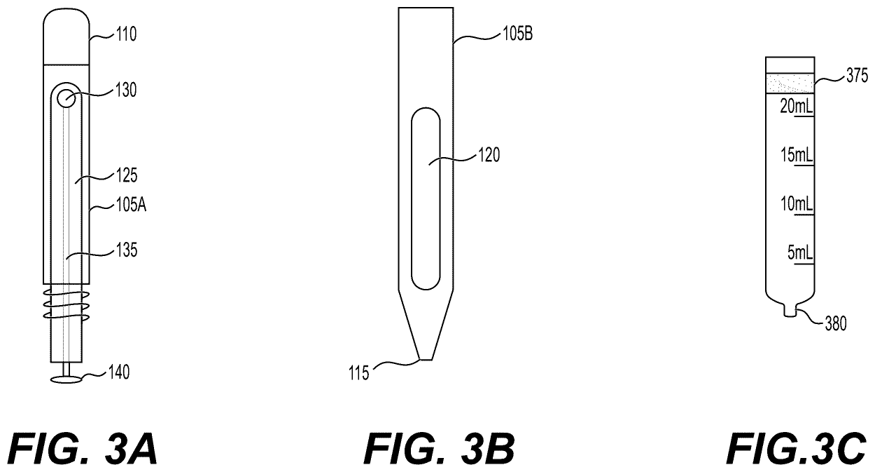

FIG. 1 depicts a front view of the all-in-one repair device 100. While in the preferred embodiment, all of the components needed for a repair are a part of device 100, in other embodiments, the invention may be a repair kit with one or more interchangeable components. Preferably device 100 is pen-shaped and sized, however device 100 can have different shapes and sizes. For example, device 100 may have an overall tubular shaped body 105 that tapers to a tip 115 (shown in FIG. 3B) at one end. Device 100 may have a circular, triangular, square, hexagonal, or other cross-section. Device 100 is preferably sized to fit within a shirt or pants pocket.

Body 105 preferably has a dispensing end 115 and a repair preparation end 110. Preferably, dispensing end 115 is conical without a point. The narrow portion of end 115 is preferably open to allow material to be dispensed therethrough. The opening's size may depend on the material to be dispensed. For example, a thicker material would have a wider opening and a thinner material would have a narrower opening. In some embodiments, dispensing end 115 may be a tip able to be removed and replaced with one or more other tips. For example, the different tips may have different sized or shaped openings for use with different materials or in different application situations. The tips may be interchangeable via a screw-in coupling, a snap-in coupling, a twist and lock coupling, a luer lock, a luer slip, or another coupling that maintains the tip in place during application of the material. Dispensing end 115 may also include a cover or lid. Preferably, the cover is removable and reattachable. For example, the cover may be removed to allow for application of the material and then reattached to prevent the remaining material from drying out. The cover may be attached via a hinge (a flip-top cap), a snap-on coupling, a twist cap, a push-pull cap, or another coupling that maintains the cover in place and minimizes exposure of the material to the air.

Repair preparation end 110 preferably has a domed shape that allows a user to imprint an indentation in the wall or other surface to be repaired in order to give space for the dispensed material to fill. In other embodiments, end 110 may have a rough surface, like sandpaper, to smooth the repair once dry.

Body 105 preferably has two windows 120 and 125. Preferably, windows 120 and 125 are cutouts in body 105. However, in other embodiments, windows 120 and/or 125 may be a see-through material, like glass or plastic. Preferably, window 120 provides a view of how much dispensable material is in device 100. Preferably, window 125 provides access to the dispensing mechanism. Depending on how the material is dispensed, the windows may be reversed or there may be only one window.

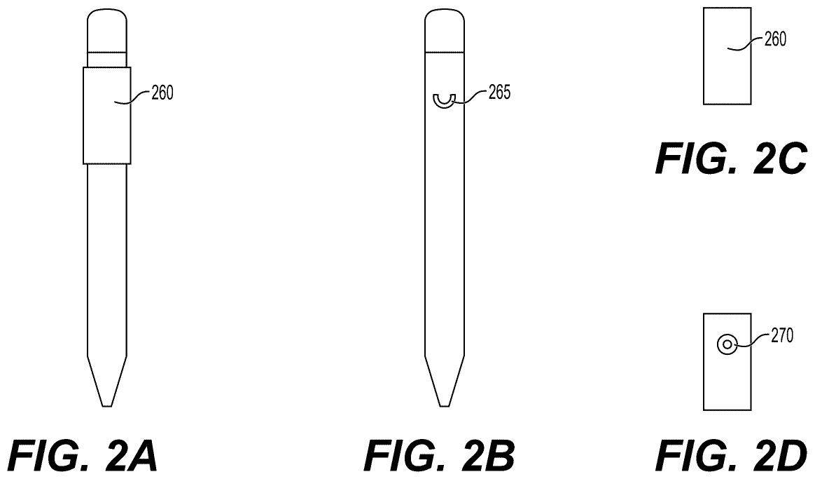

FIG. 2A depicts a back view of device 100. While the back of device 100 is shown as unadorned, it may have additional windows, instructions, logos, etc. Spatula 260 is preferably coupled to the back of device 100. Spatula 260 preferably can be used both as a pen clip and as a device to spread and smooth the material dispensed from device 100. Spatula 260 can be narrower than, equal to, or wider than body 105. Spatula 260 may be flexible or stiff. Furthermore, spatula 260 may be able to flex in one direction and be inflexible in another direction. In some embodiments, spatula 260 is fixed to body 105 while in other embodiments, as shown in FIGS. 2B-2D, spatula 260 may be removable. In other embodiments, spatula 260 may be coupled to body 105 by a hinge or be otherwise repositionable. In the removable embodiment, body 105 may have a coupling point 265 and the back side of spatula 260 may have a coupling engagement 270. For example, the coupling point 265 and coupling engagement 270 may be in the form of a snap, a threaded coupling, a removable joint coupling, or another system for attaching spatula 260 to body 105.

FIG. 3A shows the upper portion of body 105A while FIG. 3B shows the lower portion of body 105B. The two portions 105A and 105B are preferably able to be taken apart and put together multiple times. However, in single use embodiments, the two portions may not be separatable. Portions 105A and 105B are preferably coupled together with a screw-on coupling. However, in other embodiments, the two halves may be coupled by a friction fit, a locking tab, a set screw, or another coupling system.

Preferably, within upper body portion 105A is a mechanism to activate the dispensing of the material from device 100. In the embodiment shown, the mechanism is a manually manipulated plunger. The plunger preferable comprises a button 130 that a user pushes, a push plate 140 to force the material out of device 100, and a rod 135 coupling button 130 to push plate 140. In other embodiments, the mechanism may be an electromechanical device (i.e. a pump, a screw drive, or a press), another manual device, a squeeze tube, or another mechanism capable of pushing out the material.

Preferably, a vial of material (as shown in FIG. 3C) is placed within lower body portion 105B prior to the two body portions being coupled together. While a vial of material is shown herein, in other embodiments the material may be directly added to lower body portion 105B. Depending on the mechanism used to dispense the material different types of vials may be used. In the embodiment shown in FIG. 3C, the vial has a movable cork or stopper 375 that, when pushed, forces the material through opening 380. Opening 380 may have different sizes depending on the material used. The material can be, for example, spackle, joint compound, glue, paint, epoxy, wood filler, resin, ink, a solvent, or another material. The vial is preferably airtight to prevent the material from setting within the vial. As shown in FIG. 3C, the vial may have graduation marks to indicate to how much of the material is left in the vial. In other embodiments, the graduation marks may be on window 120 or there may be no graduation marks. For some uses, the vial may be able to contain two materials to be dispensed simultaneously. As button 130 is forced downward, push plate 140 engages cork 375, which in turn forces the material out of vial opening 380 and device opening 115.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. The term comprising, wherever used, is intended to include the terms consisting and consisting essentially of. Furthermore, the terms comprising, including, and containing are not intended to be limiting. It is intended that the specification and examples be considered exemplary only with the true scope and spirit of the invention indicated by the following claims.

1. A device for dispensing and applying a material, comprising:
a hollow body having a first end with a tapered tip and a second closed end, wherein the tapered tip is open to allow the material to be dispensed therethrough;
a mechanism positioned within the second closed end, wherein, when activated, the mechanism forces the material through the tapered tip; and
an applicator coupled to the hollow body.

2. The device of claim 1, wherein the material is at least one of spackle, joint compound, glue, paint, epoxy, wood filler, resin, ink, and a solvent.

3. The device of claim 1, wherein the first end is adapted to accept a cartridge of the material.

4. The device of claim 1, wherein at least one of the first end and the second end has a window to allow access to and/or viewing of the contents of the body.

5. The device of claim 1, wherein the device is pen-shaped.

6. The device of claim 1, wherein the mechanism is at least one of manually and electromechanically operated.

7. The device of claim 6, wherein the mechanism is at least one a pump, a screw drive, a plunger, or a press.

8. The device of claim 1, wherein the closed end is a surface preparation and/or surface finishing tool.

9. The device of claim 1, wherein the applicator is detachable from and re-attachable to the body.

10. The device of claim 1, wherein the device is a drywall repair tool.

11. The device of claim 1, wherein the tapered tip is removable and interchangeable with one or more additional tapered tips.

12. The device of claim 1, further comprising a lid adapted to be placed over and removed from the tapered tip.

13. A system for dispensing and applying a material, comprising:
a hollow body having a first end with a tapered tip and a second closed end;
a cartridge of the material positioned within the first end, wherein the tapered tip is open to allow the material to be dispensed therethrough;
a mechanism positioned within the second closed end, wherein, when activated, the mechanism forces the material from the cartridge and through the tapered tip; and
an applicator coupled to the hollow body.

14. The system of claim 13, wherein the material is at least one of spackle, joint compound, glue, paint, epoxy, wood filler, resin, ink, and a solvent.

15. The system of claim 13, wherein the cartridge of the material has a movable stopper adapted to press against the material and force the material out of the cartridge.

16. The system of claim 13, wherein at least one of the first end and the second end has a window to allow access to and/or viewing of the contents of the body.

17. The system of claim 13, wherein the system is pen-shaped.

18. The system of claim 13, wherein the mechanism is at least one of manually and electromechanically operated.

19. The system of claim 18, wherein the mechanism is at least one a pump, a screw drive, a plunger, or a press.

20. The system of claim 13, wherein the closed end is a surface preparation and/or surface finishing tool.

21. The system of claim 13, wherein the applicator is detachable from and re-attachable to the body.

22. The system of claim 13, wherein the system is a drywall repair tool.

23. The system of claim 13, wherein the tapered tip is removable and interchangeable with one or more additional tapered tips.

24. The system of claim 13, further comprising a lid adapted to be placed over and removed from the tapered tip.
